(19) United States
(12) Patent Application Publication
(10) Pub. No.: US 2022/0222618 A1
(43) Pub. Date: Jul. 14, 2022

(54) AN INVENTORY VERIFICATION AND TRACKING SYSTEM

(71) Applicant: TRACEBACK PTY LTD, Moonee Ponds, Victoria (AU)

(72) Inventors: Pierre KAIROUZ, Ivanhoe East, Victoria (AU); Bassem FARAH, Viewbank, Victoria (AU); Tony KAIROUZ, Ivanhoe East, Victoria (AU)

(21) Appl. No.: 17/606,469

(22) PCT Filed: Apr. 30, 2020
(86) PCT No.: PCT/AU2020/050426

§ 371 Date: Oct. 26, 2021

(30) Foreign Application Priority Data
Apr. 30, 2019 (AU) 2019901461

(51) Int. Cl. G06Q 10/08; G06K 7/10

(52) U.S. Cl. CPC G06Q 10/0833; G06K 7/10366; G06Q 10/087

(57) ABSTRACT

Described herein are systems and methods for electronically verifying and tracking shipping units. One embodiment provides a system for electronically verifying shipping unit. System includes a radio frequency identification reader device configured to wirelessly read encoded information stored in RFID tags embedded in or attached to the shipping units. The encoded information including information representative of a shipping mark which is linked to or associated with verification information for contents of the shipping unit. System also includes a processor operatively associated with the reader device and configured to: (i) process the encoded information thereby to decode the information representative of the shipping mark; (ii) access a database of stored information representative of a shipping marks; and (iii) perform a verification of the decoded information with the stored information, wherein the shipping unit is verified if the decoded information points to a shipping mark in the database having valid verification information.

### FIELD OF THE INVENTION

The present application relates to inventory monitoring and in particular to the monitoring of shipping units during shipping using RFID tags.

Embodiments of the present invention are particularly adapted for systems and methods for electronically verifying and tracking inventory between different shipping locations using RFID tags. However, it will be appreciated that the invention is applicable in broader contexts and other applications.

### BACKGROUND

The United States and other countries require imported meat, poultry or egg products from other countries to present a legible “shipping mark” (or port mark) for each shipping unit. Shipping mark details may be included on a health certificate and may be used to support the identification and traceability of the meat and meat products.

If a shipping mark is missing or illegible, the shipping unit will be rejected and will not be released into commerce.

Shipping marks are typically applied to an individual shipping unit by an adhesive label or using a stamp and ink pad or equivalent method to display the shipping mark on a shipping unit.

A problem arising from the use of stamps is that the stamp can be smudged, twisted or insufficient ink initially applied to the shipping unit causing the shipping mark to be illegible. Similarly, adhesive labels can fall off the shipping unit during transit resulting in a rejection upon arrival at the destination due to a missing or illegible shipping mark.

Another problem while applying shipping marks is that a shipping unit can be missed due to a bad scan resulting in a rejection upon arrival as it is incorrectly considered to be missing a shipping mark.

There have been frequent rejections from the US alone for missing or illegible shipping marks costing the industry millions of dollars annually.

To address the above problems, the Australian and New Zealand agribusiness AUS-MEAT Limited recently completed a trial run of a new program called “MeatMessaging”. This program uses an online portal based on GS1 barcodes and electronic messaging technologies to uniquely identify shipping units, then group the shipping units into pallets. A single shipping mark is then assigned to a pallet. This data is then electronically uploaded to the MeatMessaging portal.

Authorised users of the portal can access the MeatMessaging portal if the shipping mark is missing or illegible and can be released into commerce by scanning or manually entering the GS1 bar code of the shipping unit into the portal to verify if that GS1 bar code is included for the presented load and covered by the accompanying health certificate. However, this system is yet to be widely adopted and requires the maintenance of a secondary system in addition to the primary shipping mark system.

US Patent Application Publication 2004/0098272 entitled Computer Based System for Tracking Articles discloses a system in which radio frequency identification (RFID) labels are used to track cargo. However, this system requires constant access to a database server to perform the tracking, which is not ideal in some scenarios. Furthermore, the shipping information is stored in a database that is accessible over a network, making the information vulnerable to hacking.

The inventor has identified a desire for a more efficient and reliable method of tracking inventory, particularly in the meat and poultry shipping industries.

Any discussion of the background art throughout the specification should in no way be considered as an admission that such art is widely known or forms part of common general knowledge in the field.

### SUMMARY OF THE INVENTION

In accordance with a first aspect of the present invention, there is provided a system for electronically verifying a shipping unit, the system including:
a radio frequency identification (RFID) reader device configured to wirelessly read encoded information stored in an RFID tag embedded in or attached to the shipping unit, the encoded information including information representative of a shipping mark which is linked to or associated with verification information for contents of the shipping unit; and
a processor operatively associated with the reader device and configured to:
process the encoded information thereby to decode the information representative of the shipping mark;
access a database of stored information representative of one or more shipping marks; and
perform a verification of the decoded information with the stored information, wherein the shipping unit is verified if the decoded information points to a shipping mark in the database having valid verification information.

In some embodiments, the information representative of a shipping mark is the shipping mark itself. In other embodiments, the information representative of a shipping mark is a unique identifier representative of the shipping mark.

In some embodiments, the encoded information also includes a shipping unit identifier which uniquely identifies the shipping unit. In these embodiments, the step of performing a verification includes verifying if the shipping mark is associated with the shipping unit identifier.

In some embodiments, the RFID tag is located within the shipping unit.

In some embodiments, the verification information includes a date of production. In some embodiments, the verification information includes a net weight of the shipping unit. In some embodiments, the verification information includes a health certificate number. In some embodiments, the verification information includes a packaging date for the shipping unit.

In some embodiments, the RFID tag includes a power source within or associated with the shipping unit.

In some embodiments, the shipping unit contains one or more of meat, fish, eggs or poultry.

In some embodiments, the database of stored information is a local database. The local database may be in direct communication with the processor. Alternatively, the local database may be in communication with the database over a local network.

In some embodiments, the encoded information is stored in a Read Only Memory (ROM) section of the RFID tag. In some embodiments, this ROM section is the TID memory of the RFID tag.

In accordance with a second aspect of the present invention, there is provided a method for electronically verifying a shipping unit, the method including:
wirelessly reading encoded information stored in a radio frequency identification (RFID) tag embedded in or attached to the shipping unit, the encoded information including information representative of a shipping mark which is linked to or associated with verification information for contents of the shipping unit;
processing the encoded information thereby to decode the shipping mark;
accessing a database of stored shipping marks; and
performing a verification of the decoded shipping mark with the stored shipping marks, wherein the shipping unit is verified if the decoded shipping mark points to a shipping mark in the database having valid verification information.

In accordance with a third aspect of the present invention, there is provided a radio frequency identification (RFID) device encoded with shipping information including information representative of a shipping mark and a shipping unit identifier, the device configured to be wirelessly accessed by an RFID reader device to read the shipping information and subsequently processed by a processor to uniquely identify the shipping unit and verify the authenticity of its contents.

In accordance with a fourth aspect of the present invention, there is provided a system for electronically tracking shipping units, the system including:
a radio frequency identification (RFID) reader device configured to wirelessly read shipping information stored in an RFID tag embedded in or attached to a shipping unit, the shipping information including information representative of a shipping mark and a shipping unit identifier;
a processor operatively associated with the reader device to process the shipping information thereby to uniquely identify the shipping unit using the shipping unit identifier and verify the authenticity of its contents using the shipping mark; and
a database connected to the processor to store a record of the shipping information in association with a location identifier indicative of the location where the shipping information was read, the database being able to be subsequently queried by a server to electronically track the location of the shipping unit.

In accordance with a fifth aspect of the present invention, there is provided a method of electronically tracking shipping units, the method including:
wirelessly reading shipping information stored in a radio frequency identification (RFID) tag embedded in or attached to a shipping unit, the shipping information including information representative of a shipping mark and a shipping unit identifier;
processing the shipping information thereby to uniquely identify the shipping unit using the shipping unit identifier and verify the authenticity of its contents using the shipping mark; and
storing a record of the shipping information in association with a location identifier indicative of the location where the shipping information was read, the database being able to be subsequently queried by a server to electronically track the location of the shipping unit.

In accordance with a sixth aspect of the present invention, there is provided a method for electronically associating a shipping mark with a shipping unit using a radio frequency identification (RFID) tag, the method including:
printing an RFID tag with an encoded unique identifier;
attaching the RFID tag to a shipping unit;
wirelessly encoding a shipping unit identifier to the RFID tag using an RFID reader device, the shipping unit identifier uniquely identifying the shipping unit;
allocating a shipping mark to the shipping unit, the shipping mark being linked to or associated with verification information for contents of the shipping unit;
wirelessly encoding information representative of the shipping mark to the RFID tag using an RFID reader device; and
wherein an RFID reader device is able to read the RFID tag to extract the shipping unit identifier and shipping mark to allow verification of the contents of the shipping unit.

In some embodiments, the encoding of the shipping unit identifier and information representative of the shipping mark occurs at the same time.

In accordance with a seventh aspect of the present invention, there is provided computer system configured to implement a method according to the second, fifth or sixth aspects.

In accordance with an eighth aspect of the present invention, there is provided a computer program comprising instructions which, when executed by a computer, cause the computer to carry out the method according to the second, fifth or sixth aspects.

In accordance with a ninth aspect of the present invention, there is provided a computer-readable storage medium comprising instructions which, when executed by a computer, cause the computer to carry out the method according to the second, fifth or sixth aspects.

In accordance with a tenth aspect of the present invention, there is provided a system for verifying a shipping unit, the system including:
a radio frequency identification (RFID) reader device configured to wirelessly read encoded information stored in an RFID tag embedded in or attached to the shipping unit, the encoded information including information representative of a shipping mark which is linked to or associated with verification information for contents of the shipping unit; and
a processor operatively associated with the reader device and configured to:
   process the encoded information thereby to decode the information representative of the shipping mark; and
   display the one or more shipping marks on a display to allow a user to view the shipping mark and verify it against a database of shipping marks.

### BRIEF DESCRIPTION OF THE FIGURES

Example embodiments of the disclosure will now be described, by way of example only, with reference to the accompanying drawings in which:

FIG. 1 is a schematic illustration of a system for electronically verifying a shipping unit;

FIG. 2 is a schematic illustration of an exemplary RFID tag;

FIG. 3 is a flow chart illustrating a method of electronically verifying and tracking shipping units at an importer end of a supply chain; and

FIG. 4 is a flow chart illustrating the steps in a method of adding shipping marks during a load-out procedure.

### DESCRIPTION OF THE INVENTION

Embodiments of the invention described herein relate to systems and methods for electronically verifying and tracking shipping units between different shipping locations. The shipping units may represent a single item or a collection of like or different items packaged together within a common physical unit such as a pallet. Multiple shipping units are shipped within one or more shipping containers. In the meat and poultry industry, typical shipping units consist of meat, poultry or egg products where shipping marks are tightly regulated to ensure quality of the products. However, it will be appreciated that the principles of the present invention applies to various other tangible and comestible items capable of being shipped.

### System Overview

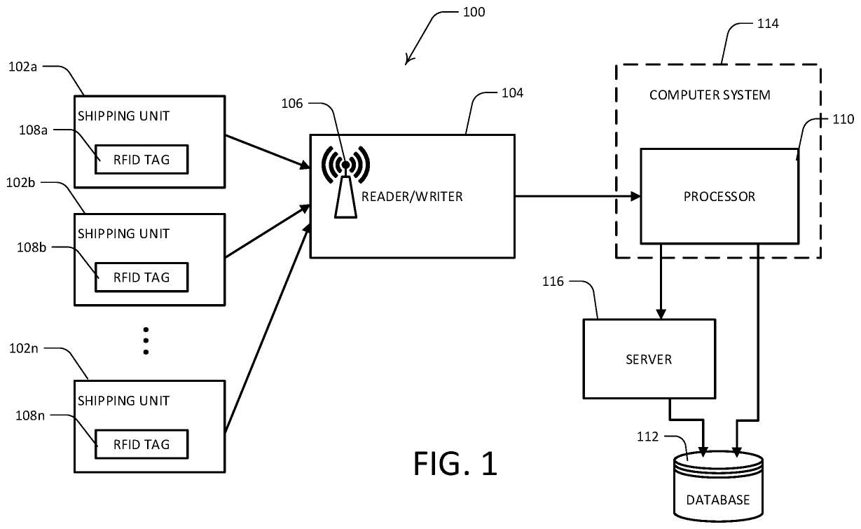

Referring initially to FIG. 1, there is illustrated a system 100 for electronically verifying a shipping unit 102. System 100 is designed for use at a downstream shipping location such as by a customs official at an import shipping port. System 100 includes a radio frequency identification (RFID) reader device 104 having a radio antenna 106 configured to wirelessly read encoded information stored in RFID tags 108 embedded in or attached to respective shipping units 102. The information encoding process is performed upstream at a location where the shipping units are packed or shipped. This encoding process is described below. Reader device 104 may also operate as a writer device also for writing data to the RFID tags at the initial data entry stage. The encoded information stored on RFID tags 108 includes information representative of a shipping mark which is linked to or associated with verification information such as a health certificate for the contents of the shipping unit. Shipping marks may be common to multiple shipping units.

Also stored on the RFID tags 108 are shipping unit identifiers which uniquely identify a respective shipping unit 102. These unique shipping unit identifiers are added before load-out of a consignment of shipping units. RFID tags 108 may be attached to an exterior or interior surface of the shipping unit itself or embedded within the packaging or contents of a shipping unit so that the RFID tag follows the associated shipping unit. Preferably, RFID tags 108 are stored in locations on or within shipping units 102 that are not readily accessible by other parties.

Thus, during shipment of a shipping unit, an associated RFID tag includes at least the following encoded information:
An RFID tag identifier that is unique to the RFID tag and added during manufacture of the tag.
A shipping unit identifier which is unique to the specific shipping unit.
A shipping mark which is linked to or associated with verification information which verifies the contents of the shipping unit upon import or through an interim shipping stage.

The shipping mark is of a format that is mutually agreed upon between trading partners and typically represents a 1 to 30 digit alphanumeric code. An example format of a shipping mark is “AAA012345678”. However, a shipping mark may comprise any sequence of numbers, letter or symbols or combinations thereof that can be used to uniquely identify verification information associated with contents of a shipping unit.

As described below, the RFID tags 102 may include both a Read Only Memory (ROM), such as a TID memory, and an Electronically Erasable Programmable Read Only Memory (EEPROM), such as EPC memory and User memory. Preferably this encoded information is stored on an RFID tag in the ROM memory so that it is “locked” upon entry and cannot be modified or tampered. This provides additional security. However, in other embodiments, the encoded information may be stored in the EEPROM memory so as to allow multiple uses of the RFID tag with different information.

A processor 110 is operatively associated with the reader device and configured to process the encoded information thereby to decode the shipping mark and optionally also the shipping unit identifier. Processor 110 accesses a database 112 of stored shipping marks and performs a verification of the decoded shipping mark with the stored shipping marks. A shipping unit 102 is verified if the decoded shipping mark information points to a valid shipping mark in the database which is associated with valid verification information such as a valid health certificate. For example, the shipping mark matches one of the stored shipping marks in database 112.

A second level of verification may be performed by also decoding the shipping unit identifier and verifying that the shipping mark matches the shipping mark assigned to the shipping unit.

Processor 110 may form part of a computer system 114. Computer system 114 may include a single computer such as a personal computer, or may include a system of distributed computing resources either co-located or geographically spatially distributed. Processor 110 may host one or more software applications for performing the decoding and other functions such as writing to the RFID tags described below.

Database 112 may be connected directly with processor 110 in which database 112 represents a “local” database, or be connected through a server 116. Server 116 may be co-located with processor 110 and database 112 or may be remotely located and accessed over the internet (such as a cloud-based server). Similarly, database 116 may be located remotely from processor 110 and accessed via server 116 in cloud-based manner.

A “local” database refers to a database that is accessible via processor 110 without an internet connection or server. Although processor 110 and/or database 112 may be connected to the internet, in a “local” connection, processor 110 is able to access data from database 112 without the need for an internet or other remote connection. A local connection may still involve connection between multiple device such as a Local Area Network installed within a customs facility but does not extend beyond that local network.

Use of a local database has the advantage of the system not requiring an internet connection during the verification process. By way of example, a customs worker may scan shipping unit 102 locally using a hand-held RFID reader device 104 when the shipping unit is located in an area outside of internet coverage. Local storage of shipping marks allows the data read by reader device 104 to be compared with the stored shipping marks and a local verification process performed without internet connection. The information may be stored on database 112 previously via download from the internet of upload from a user by entering the data via a portable memory device or via a user interface.

In some embodiments, the stored shipping marks are included on a digital manifest of shipping units, which includes a list of valid shipping marks. This digital manifest may be downloaded to database 112 or entered by a user. In other embodiments, the stored shipping marks may be included in a physical manifest of shipping units, which includes a list of valid shipping marks. A manual verification process may be performed by a worker by scanning a RFID tag and checking the displayed shipping mark with those listed on the physical manifest. This technique bypasses the need for database 112 but involves more manual work by a user.

In one embodiment, only the RFID tag identifier, shipping mark and the shipping unit identifier are encoded onto the RFID tag. This information is sufficient for processor 110 to retrieve all relevant information from database 112 to uniquely identify the RFID tag, the associated shipping unit and verify its contents. For example, the relevant information retrieved from database 112 may include:
A description of the inventory of the shipping unit (e.g. one or more of meat, fish, eggs or poultry);
A date of production of the inventory contents;
A net weight of the shipping unit;
Supplier information (e.g. company name, location and registration number);
Destination or customer information;
A health certificate number; and
A packaging date for the shipping unit.

In addition to the shipping mark, additional shipping information, including that listed above, may also be encoded into the memory of the respective RFID tags 108.

All of the information encoded onto the RFID tags is encoded before the unit is shipped. This encoding process typically takes place at the location of packaging or containerisation. Before an RFID tag is attached to a shipping unit. An RFID enabled printer prints a tag with a unique barcode and encodes a unique identifier onto the RFID tag. The RFID tag is typically but not necessarily stored in the TID memory section of the device, which is read-only. The RFID tag is then attached to a shipping unit via an adhesive or other attachment means. Record of the RFID tag identifier, shipping mark and the shipping unit identifier are stored on a server or local database.

The encoding process may follow any one of the standardised data encoding protocols. By way of example, the shipping information, including the shipping mark and shipping unit identifier, may be encoded into the RFID tags 108 using standards documented by EPCGlobal (GS1) to identify a trade item using a Global Trade Identification Number (GTIN) and/or a serial number or Serial Shipping Container Code (SSCC) written to an EPC memory bank.

The RFID tag may be tamper resistant. For example, the stored information can be encrypted/ decrypted or locked/unlocked depending on a desired security level.

RFID tags 108 are configured to have data initially written thereto for encoding the relevant data. In some embodiments, reader 104 also has a writing capability to perform this encoding process. In other embodiments, a separate data writing device (not shown) is used. For example, the shipping units 102 may be ready for export and may need a shipping mark and/or a shipping unit identifier to be attached to the shipping unit 102. Reader 104 writes a shipping mark to the RFID tag 108. Other information such as the production date and certificate identification may also be written to the RFID tag or written/printed on the shipping unit itself. Thus, the shipping mark remains with the shipping unit 102 throughout its freight journey and can be verified whenever needed. This is beneficial for the exporter where the shipping units 102a-n may need a shipping mark attached to a shipping unit and the importer requires that shipping mark to verify a shipping unit 102. The RFID tags 108a-n can be read by reader 104 at the freight destination or other intermediate locations to determine if a shipping mark is present or not and therefore verify the shipping unit.

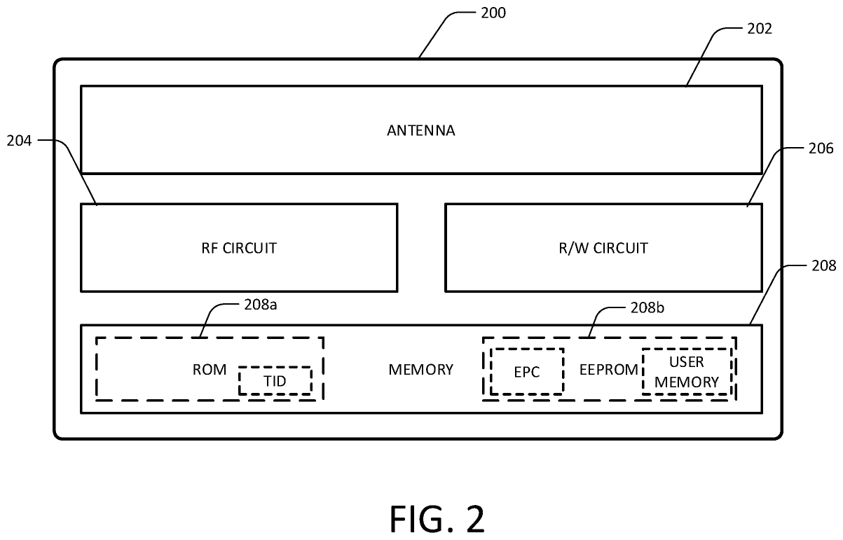

Referring now to FIG. 2, there is illustrated schematically an exemplary RFID tag 200, which may be representative of tags 108a-n. RFID tag 200 includes an antenna 202, a radio frequency (RF) circuit 204, a read/write (R/W) circuit 206, and a memory 208. RFID tag 200 may be a ‘passive’, ‘active’ or ‘semi-passive’ device, in which the tag is unpowered, internally powered or internally powered to transmit respectively. As such, the RFID tag may be independently powered from the shipping unit and/or be powered on demand.

Memory 208 comprises both a Read Only Memory (ROM) 208a and an Electronically Erasable Programmable Read Only Memory (EEPROM) 208b. ROM 208a may comprise a TID memory, which is typically reserved for storing the unique identifier or ID number that identifies the RFID tag. This ID number is stored in the TID memory during manufacture. The EEPROM 208b may comprise Electronic Product Code (EPC) memory, which has a minimum of 96 bits of writable memory and is typically used as the first writable memory bank for many applications. EEPROM 208b may also comprise User memory, which is a larger memory bank of typically up to around 512 bits. However, larger capacity user memories are available.

Information written to ROM 208a is not able to be modified or overwritten while information in EEPROM 208b may be erased, modified or overwritten with new data. In preferred embodiments of the invention, the shipping mark and shipping unit identifier are encoded onto an RFID tag in the ROM memory for added security to restrict other parties from tampering with the shipping mark and shipping unit identifiers.

Antenna 202 is responsible for receiving and optionally transmitting (in the case of an active RFID tag) radio frequency signals. The RF circuit 204 is responsible for demodulating received information from a reader device and optionally modulating information transmitted from the RFID tag 200 (in the case of an active RFID tag). The R/W circuit 206 controls the reading from memory 208 and optionally writing to the memory 208 in the case of an active RFID tag. The memory 208 may be a write-once memory or may be a re-writeable memory. Each of the components of RFID tag 200 may be included on an integrated circuited embedded within a housing (not shown).

During a data writing process, a writing device such as an RFID printer transmits radio waves to the RFID tag with information encoded into the waves through a modulation protocol. These RF waves are received by antenna 202 and the information is demodulated by RF circuit 204. The information is written to memory 208 by the R/W circuit. Through this process, an encoded shipping mark and shipping unit identifier can be stored in memory 208 of an RFID tag. As mentioned above, preferably the information is stored in ROM 208a. However, in some embodiments, the information may be stored in EEPROM 208b.

It will be appreciated that the components shown in FIG. 2 are exemplary only and, in other embodiments, one or more of the components shown in FIG. 2 may be omitted and/or other components included in RFID tag 200.

For example, more advanced RFID tags referred to as “Gen 2” RFID Tags, include an EPC memory bank and a user memory bank. Additional information above and beyond the shipping mark and shipping unit identifier may be stored onto an RFID Tag using the user memory bank. The data encoded/decoded to/from the user memory bank using the “Packed Objects” access method supporting all GS1 application identifiers. The data stored to the user memory bank preferably conforms to EPC Tag Data Standards 1.9/ISO 15962.

In some embodiments, the RFID tag is an active tag and includes a power source such as one or more batteries located within or associated with the shipping unit.

System 100 is suitable, for example, for use by an importer who receives shipping units from another region or country. In some embodiments, system 100 is also capable of facilitating tracking of shipping units. In a tracking operation, database 112 may also be configured to store a record of the shipping information (including the shipping mark and/or the shipping unit identifier) in association with a location identifier indicative of the location where the shipping information was read. For example, if the RFID tag is read at an arrival shipping port then the shipping information is stored in association with a location identifier indicative of that shipping port.

For the purpose of tracking the shipping units 102, database 112 is able to be subsequently queried by server 116 (or another server) to electronically track the location of the shipping units.

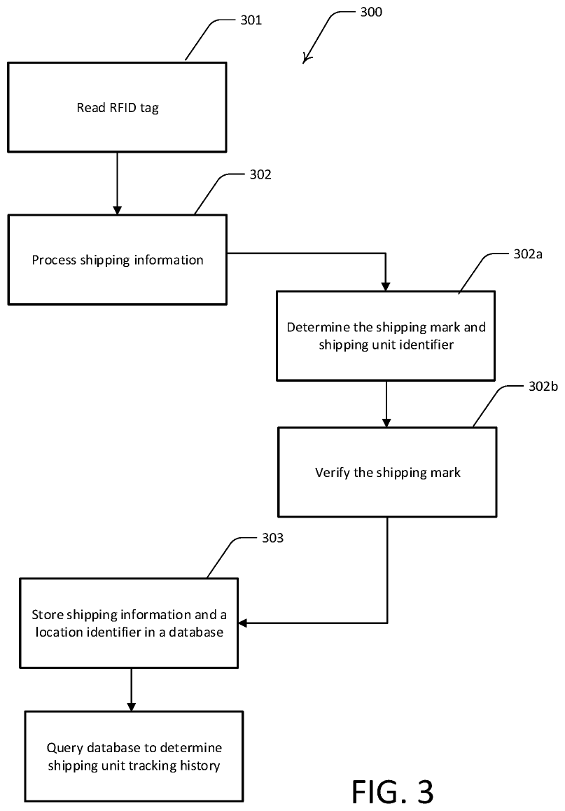

FIG. 3 illustrates a typical flow chart of a method 300 of electronically verifying and tracking shipping units at an importer end of the supply chain. Method 300 may be carried out by system 100 described above or by other similar systems. Upon receipt of shipping units 102a-n, at step 301, reader 104 wirelessly reads shipping information stored in the associated RFID tags 108a-n embedded in or attached to the shipping units 102a-n. The shipping information includes the encoded shipping mark and the shipping unit identifier.

At step 302, the decoded shipping information is passed to processor 110 where the shipping information is processed to uniquely identify the shipping unit using the shipping unit identifier and verify the authenticity of its contents using the shipping mark. This includes, at step 302a, decoding the shipping mark and shipping unit identifier using appropriate decoding software and, at step 302b, verifying the shipping mark in the manner described above. Step 302b may also include verifying that the shipping mark matches the assigned shipping unit by verifying the shipping unit identifier.

At step 303, a record of the shipping information is stored in database 112 in association with a location identifier indicative of the location where the shipping information was read. By way of example, the location identifier may be geographical coordinates of the port of import. The location identifier may also be a descriptive identifier of the port of import which is associated with a predefined location such as a city, state and/or country. The shipping information may include a time of departure and/or time of arrival of the shipping unit.

At step 304, database 112 is able to be subsequently queried by server 116 to electronically track the location of the shipping unit through different ports and geographic locations.

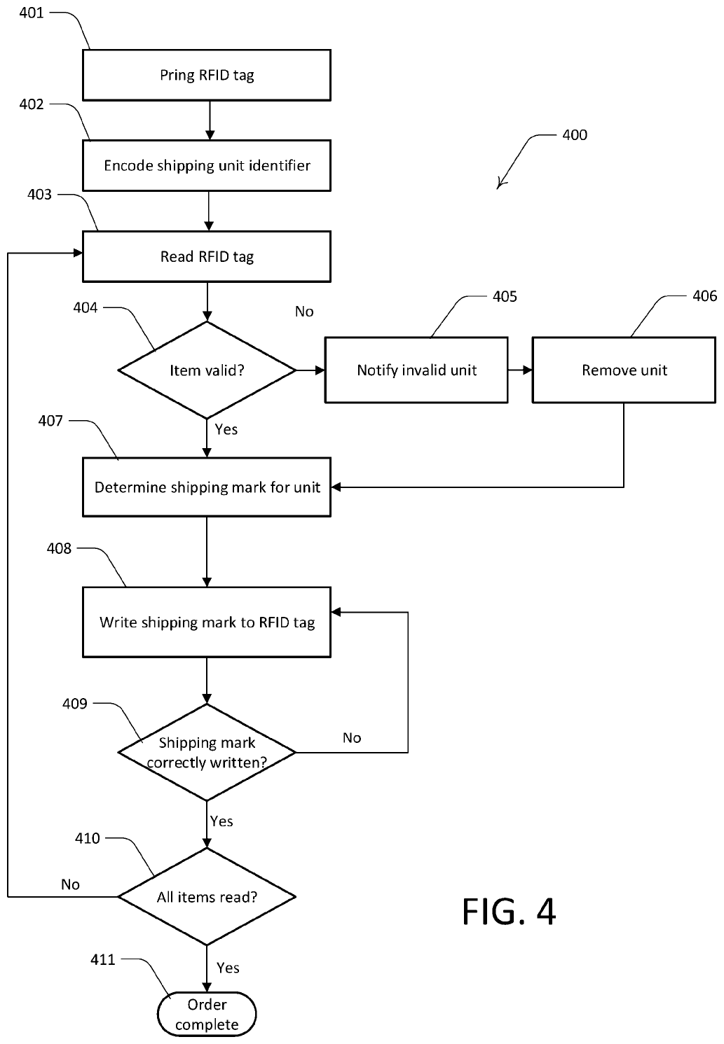

Referring now to FIG. 4, there is illustrated a flow chart of steps in a method 400 of adding shipping marks during a load-out procedure. Method 400 may be implemented by system 100 described previously wherein reader 104 operates as a writer to write data to an RFID tag. Initially, shipping units 102a-n that have been placed on order are presented for load-out onto a shipping container that may be temperature controlled.

Before an RFID tag is attached to a shipping unit. At step 401, an RFID enabled printer prints an RFID tag 108 and encodes a unique identifier onto the RFID tag. The RFID tag may also be printed with a unique barcode for optical scanning. The RFID tag is then attached to a shipping unit via an adhesive or other attachment means. At step 402, a writing device, such as reader/writer 104, is used to encode a shipping unit identifier to the RFID tag. The shipping unit identifier is unique to the shipping unit to which the RFID tag has been adhered.

Before the shipping units are loaded onto the shipping container, one or more unique shipping marks are allocated to each of the shipping units selected for shipment based on the shipping unit identifier. This allocation process may be performed manually by a user or automatically allocated by processor 110. At step 403, reader 104 wirelessly reads the shipping unit identifier, which has been pre-recorded in the associated RFID tag 108a-n embedded in or attached to shipping units 102a-n.

At step 404, processor 110 determines whether each shipping unit has been assigned to a particular order. If that shipping unit is not included in the order or if an extra shipping unit has been presented, at step 405, processor 110 notifies a user of the system via a visual or audible queue (e.g. via computer system 114) that the shipping unit 102 should not be included in the load-out.

At step 406, the user is able to remove the invalid shipping unit 102 and continue the flow.

At step 407, processor 110 checks if the importer requires a shipping mark for a shipping unit. If a shipping mark is required but is not present on the RFID tag at this stage, at step 408 processor 110 generates and writes a shipping mark to the RFID tag using a writing device such as reader/writer 104. Alternatively, processor 110 generates and writes a unique identifier that is representative of the shipping mark to the RFID tag. This unique identifier is associated with the shipping mark such that the shipping mark can be extracted from database 112 by processor 110. This writing process is performed by processor 110 accessing database to identify the shipping unit identifier, determining the corresponding shipping mark or marks that has been allocated to that shipping unit and communicating this information to reader/writer 104. The reader/writer 104 then writes the shipping mark or unique identifier representative of the shipping mark to the RFID tag.

At step 409, the system may attempt to write the shipping mark to the RFID tag in an event where an unsuccessful write of a shipping mark occurred to the RFID tag. At this stage, the system may notify the user to replace the RFID tag that may be faulty with a new tag and step 408 performed again.

At step 410, processor 110 determines whether all of the shipping units have been read. If not, steps 403 to 409 are performed on each additional unit until all of the shipping units have been read. Finally, at step 411, the processor 110 determines that all shipping units have been read and the order is deemed ready for export.

In some embodiments, the writing of the shipping mark to the RFID tag occurs during step 402 when the shipping unit identifier is encoded onto the tag. It will be appreciated that, in other embodiments, writing/encoding the shipping mark or unique identifier that is representative of the shipping mark can occur at other stages before a shipment is sent, including when the RFID tag is printed.

As described above, the RFID tags 102 may store the shipping mark, shipping unit identifier, production date and other information in its memory. The RFID tag may be updated with other information at various points in the production lines and supply chain if that RFID tag supports read/write capability. The RFID tag may be updated to store the shipping mark, certificate information, consignment information or other relevant information.

Another aspect of the invention relates to RFID device encoded with shipping information including information representative of a shipping mark. The RFID device is configured to be wirelessly accessed by reader device 104 to read the shipping information and subsequently processed by processor 110 to uniquely identify the shipping unit.

In an alternative embodiment, the above functionality can be supported simply using the RFID tag identifier as a unique pointer with all other information (including the shipping mark and shipping unit identifier) stored in database 112. In this embodiment, only the RFID tag identifier is stored on an RFID tag and this identifier is read where necessary to access an associated record in database 112 which contains all of the information relevant to the shipping unit and, its contents and verification information. Thus, at an import location, the RFID tag identifier is read by a reader device and this number points to a corresponding shipping mark and shipping unit identifier stored in database 112.

The above described system may be used to verify if a shipping mark has been correctly encoded before a shipping unit is loaded onto a container for export and for verifying correct units at a shipping destination. At the loading stage, in a case where a shipping mark has not been correctly encoded, an associated RFID tag can be encoded with the shipping mark to ensure the shipping unit is correctly tracked and verified at an arrival port.

Due to the speed of RFID encoding, the encoding of a shipping mark (or a unique identifier representative of a shipping mark) and a shipping unit identifier onto an RFID tag speeds up the process of manually applying the shipping mark to each shipping unit. Furthermore, this process also reduces the risk that shipping units are inadvertently not applied with a shipping mark before exportation or lose a discernible shipping mark during shipping.

### Interpretation

Unless specifically stated otherwise, as apparent from the following discussions, it is appreciated that throughout the specification discussions utilizing terms such as “processing,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “controller” or “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Embodiments described herein are intended to cover any adaptations or variations of the present invention. Although the present invention has been described and explained in terms of particular exemplary embodiments, one skilled in the art will realize that additional embodiments can be readily envisioned that are within the scope of the present invention.

What is claimed is:

1. A system for electronically verifying a shipping unit, the system including:
a radio frequency identification (RFID) reader device configured to wireles sly read encoded information stored in an RFID tag embedded in or attached to the shipping unit, the encoded information including information representative of a shipping mark which is linked to or associated with verification information for contents of the shipping unit; and
a processor operatively associated with the reader device and configured to:
process the encoded information thereby to decode the information representative of the shipping mark;
access a database of stored information representative of one or more shipping marks; and
perform a verification of the decoded information with the stored information, wherein the shipping unit is verified if the decoded information points to a shipping mark in the database having valid verification information.

2. The system according to claim 1 wherein the information representative of a shipping mark is the shipping mark itself.

3. The system according to claim 1 wherein the information representative of a shipping mark is a unique identifier representative of the shipping mark.

4. The system according to claim 1 wherein the encoded information also includes a shipping unit identifier which uniquely identifies the shipping unit.

5. The system according to claim 4 wherein the step of performing a verification includes verifying if the shipping mark is associated with the shipping unit identifier.

6. The system according to claim 1 wherein the RFID tag is located within the shipping unit.

7. The system according to claim 1 wherein the verification information includes a date of production.

8. The system according to claim 1 wherein the verification information includes a net weight of the shipping unit.

9. The system according to claim 1 wherein the verification information includes a health certificate number.

10. The system according to claim 1 wherein the verification information includes a packaging date for the shipping unit.

11. The system according to claim 1 wherein the RFID tag includes a power source within or associated with the shipping unit.

12. The system according to claim 1 wherein the shipping unit contains one or more of meat, fish, eggs or poultry.

13. The system according to claim 1 wherein the database of stored information is a local database.

14. The system according to claim 1 wherein the encoded information is stored in a Read Only Memory (ROM) section of the RFID tag.

15.-17. (canceled)

18. A method of electronically tracking shipping units, the method including:
wireles sly reading shipping information stored in a radio frequency identification (RFID) tag embedded in or attached to a shipping unit, the shipping information including information representative of a shipping mark and a shipping unit identifier;
processing the shipping information thereby to uniquely identify the shipping unit using the shipping unit identifier and verify the authenticity of its contents using the shipping mark; and storing a record of the shipping information in association with a location identifier indicative of the location where the shipping information was read, the database being able to be subsequently queried by a server to electronically track the location of the shipping unit.

19. A method for electronically associating a shipping mark with a shipping unit using a radio frequency identification (RFID) tag, the method including:
printing an RFID tag with an encoded unique identifier;
attaching the RFID tag to a shipping unit;
wirelessly encoding a shipping unit identifier to the RFID tag using an RFID reader device, the shipping unit identifier uniquely identifying the shipping unit;
allocating a shipping mark to the shipping unit, the shipping mark being linked to or associated with verification information for contents of the shipping unit;
wirelessly encoding information representative of the shipping mark to the RFID tag using an RFID reader device; and
wherein an RFID reader device is able to read the RFID tag to extract the shipping unit identifier and shipping mark to allow verification of the contents of the shipping unit.

20. The method according to claim 19 wherein the encoding of the shipping unit identifier and information representative of the shipping mark occurs at the same time.

21. A computer system configured to implement a method according to claim 18.

22. A computer program comprising instructions which, when executed by a computer, cause the computer to carry out the method according to claim 18.

23. A computer-readable storage medium comprising instructions which, when executed by a computer, cause the computer to carry out the method according to claim 18.

24. (canceled) .
